(19) United States
(12) Patent Application Publication
(10) Pub. No.: US 2009/0106643 A1
(43) Pub. Date: Apr. 23, 2009

(54) IMAGE FORMING APPARATUS AND METHOD OF MANAGING DOCUMENT THEREOF

(75) Inventors: Hyun-sun KIM, Hwaseong-si (KR); Hyun-cheol Park, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/209,346

(22) Filed: Sep. 12, 2008

(30) Foreign Application Priority Data
Oct. 18, 2007 (KR) 10-2007-0104892

(51) Int. Cl. G06F 17/00

(52) U.S. Cl. 715/234

(57) ABSTRACT

An image forming apparatus includes a storage unit, an operating unit to receive a selection of a document to be linked to a current document, and a controller to link information regarding the selected document to the current document using the operating unit, and to store the current document including the information in the storage unit. Therefore, a linked document may be set to a document, so it is possible to manage documents with greater convenience.

### CROSS-REFERENCE TO RELATED APPLICATIONS

This application claims priority under 35 U.S.C. §119(a) of Korean Patent Application No. 10-2007-0104892, filed on Oct. 18, 2007, in the Korean Intellectual Property Office, the disclosure of which is incorporated herein by reference in its entirety.

### BACKGROUND OF THE INVENTION

1. Field of the Invention

The present general inventive concept relates to an image forming apparatus and a method of managing documents thereof. More particularly, the present general inventive concept relates to an image forming apparatus capable of setting one or more linked documents related to a current document so that it is possible to easily check and manage the one or more linked documents, and a method of managing one or more documents in the image forming apparatus.

2. Description of the Related Art

Due to the automatization of offices, various input/output devices have become increasingly used. Among such input/output devices, laser beam printers, light emitting diode (LED) print head (LPH) printers, copiers and facsimile machines are collectively referred to as image forming apparatuses.

Conventional image forming apparatuses, such as printers, copiers, scanners and facsimile machines, each perform a separate function. However, the recent development of digital technologies has brought the advent of multifunctional peripherals (MFPs) combining various functions in a single device.

Widely used image forming apparatuses include large capacity storage devices, in which it is possible to store a large number of documents. Additionally, such image forming apparatuses can be connected to networks, and thus a plurality of users may share and print documents stored in a single image forming apparatus. Such image forming apparatuses perform jobs using a single document stored therein. In recent years, other documents associated with a document currently in use, for example, reference documents, attached files and the like, are also used.

However, in a conventional image forming apparatus, it is difficult to check whether documents related to the current document exist or not, and whether such documents are stored in the image forming apparatus even if such documents also exist. Additionally, it is also hard to search for such documents. This inconvenience may increase when a specific document is used frequently.

### SUMMARY OF THE INVENTION

The present general inventive concept provides an image forming apparatus and a method for managing a document thereof, by which the image forming apparatus sets a linked document related to a current document so that it is possible to easily check and manage the linked document that may be used repeatedly together with the current document.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of managing a document in an image forming apparatus, the method including receiving a selection of a document to be linked to a current document, and storing information regarding the selected document to be linked, in the current document.

The receiving may include, if the document to be linked is selected from among previously stored documents, displaying the previously stored documents and receiving a selection of at least one of the displayed documents; and if the document to be linked is a document to be scanned, activating a scanning function to scan the document to be linked.

The previously stored documents may be stored in a storage medium of the image forming apparatus or in a storage medium of an external host device connected to the image forming apparatus.

The method may further include receiving a setting of at least one of a link location and a link attribute.

The link attribute may be at least one of a link attribute validity period and information regarding whether a linked document is automatically printed.

The foregoing and/or other aspects and utilities of the present general inventive concept may also be achieved by providing a method for managing a document in an image forming apparatus, the method including receiving a selection of a current document to which at least one document is linked; and displaying information regarding the linked document on a link location pre-set in the selected current document.

The method may further include, if the displayed information regarding the linked document is selected, displaying the linked document corresponding to the selected information, instead of the current document.

The method may further include, if the displayed information regarding the linked document is selected, displaying the selected information together with the linked document corresponding to the selected information.

The foregoing and/or other aspects and utilities of the present general inventive concept may also be achieved by providing a method for managing a document in an image forming apparatus, the method including receiving a selection of a current document to which at least one document is linked; and printing at least one of the current document and the linked document.

The method may further include receiving a selection of whether the linked document is printed. The printing may include printing the linked document according to a user's selection.

The foregoing and/or other aspects and utilities of the present general inventive concept may also be achieved by providing an image forming apparatus including a storage unit, an operating unit to receive a selection of a document to be linked to a current document, and a controller to link information regarding the selected document to the current document using the operating unit, and to store the current document including the link information in the storage unit.

The image forming apparatus may further include a scanning unit. The document to be linked may be a document scanned by the scanning unit.

The image forming apparatus may further include a display unit to display documents previously stored in the storage unit. The controller may link a document selected from among the displayed documents to the current document.

If at least one of a link location and a link attribute of the linked document is selected through the operating unit, the controller may match the selected link location and link attribute to the current document and store the matched document in the storage unit.

The link attribute may be at least one of a link attribute validity period and information regarding whether a linked document is automatically printed.

The image forming apparatus may further include a display unit to display the current document together with information regarding the linked document, if a command to display the current document is received.

If the information regarding the linked document displayed on the display unit is selected, the controller may display the linked document corresponding to the selected information on the display unit, instead of the current document.

If the information regarding the linked document displayed on the display unit is selected, the controller may display the selected information together with the linked document corresponding to the selected information on the display unit.

If a command to print the current document is received, the controller may print at least one of the current document and the linked document.

The controller may print the linked document according to a user's selection.

The foregoing and/or other aspects and utilities of the present general inventive concept may also be achieved by providing a computer-readable medium to contain computer-readable codes as a program to execute a method of managing a document in an image forming apparatus, the method including receiving a selection of a document to be linked to a current document, and storing information regarding the selected document to be linked, in the current document.

The foregoing and/or other aspects and utilities of the present general inventive concept may also be achieved by providing an image forming apparatus including a controller to generate information on a document and a second document linked to the document and to perform an operation on the document and the linked document.

The image forming apparatus may further include a display unit to display the information.

The image forming apparatus may further include a scanning unit to scan an external document as at least one of the document and the linked document.

The image forming apparatus may further include a printing unit to print at least one of the document and the linked document.

The operation may include one of a printing operation to print the document and the linked document, a displaying operation to display the document and the linked document, a scanning operation to scan at least one of the document and the linked document, a communicating operation to communicate with an external device to receive and transmit the document and the linked document.

### BRIEF DESCRIPTION OF THE DRAWINGS

The above aspects and features of the present general inventive concept will be more apparent by describing certain embodiments of the present general inventive concept with reference to the accompanying drawings, in which:

FIG. 1 is a block diagram illustrating an image forming apparatus according to an exemplary embodiment of the present general inventive concept;

FIGS. 2 to 4 are exemplary views illustrating various examples of a user interface window displayed in the image forming apparatus of FIG. 1; and

FIGS. 5 to 7 are flowcharts illustrating a document managing method according to exemplary embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

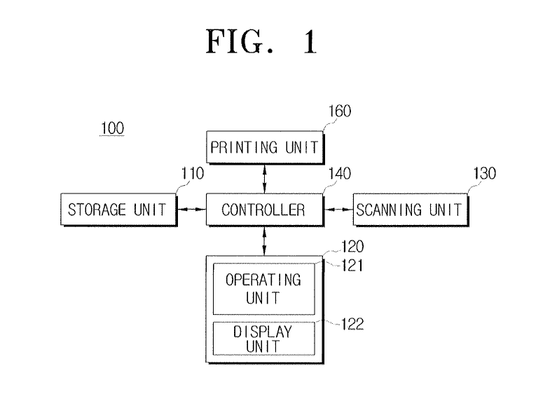

FIG. 1 is a block diagram illustrating an image forming apparatus 100 according to an exemplary embodiment of the present general inventive concept.

The image forming apparatus 100 of FIG. 1 includes a storage unit 110, a user interface unit 120, a scanning unit 130, a controller 140, and a printing unit 160.

The storage unit 110 stores one or more documents and information regarding each of the documents. Specifically, the storage unit 110 may store one or more documents required to perform one or more jobs in the image forming apparatus 100, and information regarding the documents, for example, document attributes and link information such as the user, date of creation, date of the last update, type of job, document name and the like. Additionally, the link information may be stored in a log file or an information file which is linked to the original document.

The jobs correspond to, for example, a printing operation to print a document on a print medium using a printing unit, a scanning operation to scan a document using a scanning unit, a transmission operation to transmit and receive a document using an interface communicating with an external device, and so on in an image forming apparatus. The jobs can be performed in components of the image forming apparatus 100 or can be performed in a device connected to the image forming apparatus 100. The job can be performed in a combination of the image forming apparatus 100 and an external device.

The printing unit 160 may have a unit to feed a print medium, a unit to form an image according to data corresponding to a document on the fed print medium, and a unit to discharge the print medium. A conventional print unit 160 may be used as the printing unit 160. However, the printing unit 160 communicates with the controller 140 to receive data corresponding to the document and a control signal to control the units to perform the jobs.

The user interface unit 120 provides a user interface to receive one or more user commands, or to display a current state of the image forming apparatus 100, a document list having one or more documents, and a document content of a corresponding document. The user interface unit 120 includes an operating unit 121 and a display unit 122.

The operating unit 121 enables a user to select a document to be linked to a current document. The operating unit 121 may be a user interface to output signals to select and request functions supported by the image forming apparatus 100, and may be implemented as a touch panel or a plurality of buttons. Additionally, the user may select a document to be linked to a current document currently in use using the operating unit 121, so that the required management may be performed.

The display unit 122 displays results according to the current state of the image forming apparatus 100, a job list, and link attributes set through the operating unit 121. Specifically, when a user interface window is displayed on a screen of the image forming apparatus 100, the display unit 122 may display the current document and a list of documents linked to the current document on one side of the user interface window.

The scanning unit 130 scans an image recorded on a printing medium.

The controller 140 links information regarding the document to be linked selected using the operating unit 121 to the current document, and stores the current document including the link information in the storage unit 110. Specifically, if a user desires to set a selected document to be a linked document by selecting one from among the documents previously stored in the image forming apparatus 100, the controller 140 may record that the linked document selected by the user exists with information regarding the current document, to generate link information. Additionally, the link information may be stored as attributes of the current document, or in a separate log file and information file. For example, if a user desires to link document 2 to document 1, the controller 140 may record that document 2 is linked to information regarding document 1. Accordingly, document 1 may be linked to both the information regarding document 1 and information regarding document 2.

The controller 140 may receive a setting regarding whether the document to be linked is a new document or a previously stored document through the operating unit 121. In more detail, the document to be linked may be a document stored in the storage unit 110 or a new document, which is not stored in the storage unit 110. Accordingly, the controller 140 may receive a setting regarding the type of document through the operating unit 121. If the document to be linked is a new document, the controller 140 may activate and control the scanning unit 130 to scan the new document, so that the scanned document may be stored in the storage unit 110. Additionally, the controller 140 may store the scanned document in a storage medium of an external host device, for example a terminal device or a server, connected to the image forming apparatus 100. The controller 140 may then record that the scanned document is linked to the current document in the information regarding the current document.

Alternatively, if the document to be linked is a previously stored document, the controller 140 may classify the documents previously stored in the storage unit 110 according to the document attributes, and may control the display unit 122 to display the classified documents. The controller 140 may receive a selection of the document to be linked from among the displayed documents using the operating unit 121. The previously stored documents may be documents stored in the storage unit 110 of the image forming apparatus 100, and documents stored in a storage medium (not shown) of an external host device connected to the image forming apparatus 100.

Specifically, the controller 140 may classify the previously stored documents according to document attributes such as the user, date of creation, date of the last update, type of job, document name or the like, so that the classified documents may be displayed on the display unit 122. For example, if document 1 is currently activated by user A, documents related to document 1 may have names similar to that of document 1 and to those of documents which user A has edited. Accordingly, it is possible to classify and display documents to be linked, according to their document attributes.

If a link location and link attributes are selected using the operating unit 121, the controller 140 may match the current document according to the selected link attributes, and may store the matched document in the storage unit 110. In more detail, the controller 140 may receive attributes regarding which form is used to display the linked document, which location in the current document the linked document is displayed on, and how to display the linked document, input by the user using the operating unit 121. The controller 140 may then record the attributes in the information regarding the current document. The link location may optionally be set in advance.

For example, attributes such as symbols, the form color and location of the symbols, whether the form has a flicker effect, and underlining can be set. The attributes may be stored in the link attributes of the information regarding the document. Additionally, information regarding how long the link information is valid may be stored in the attributes.

If the user selects a document in which the link information is recorded, the controller 140 may display content of the document together with the information regarding the linked document. Specifically, the controller 140 may display whether the linked document exists in the current document, and the link information using the link location and link attributes. Additionally, the controller 140 may display the linked document in a separate window instead of the window wherein the current document is displayed, and may control the current document to be displayed along with the linked document by adjusting the size of a window in which the linked document may be displayed together with the current document. In this exemplary embodiment of the present general inventive concept, the controller 140 may control icons such as “□” in the document list to be displayed so that the user may be informed that the current document contains the link information.

If a command is received to print the document on which the link information is recorded, the controller 140 may control the display unit 122 to display whether the document is printed together with the linked document. Additionally, the controller 140 may control the linked document to be printed, according to the user's selection using the operating unit 121.

The controller 140 may generate a signal representing a display image or an interface to show one or more document and one or more linked documents displayed on the display unit 122, and generate another signal to the printing unit 160 to print the document and/or the linked document according to a user selection on the one or more document and one or more linked documents.

Here, the document and the linked document may be a document to be scanned, a document previously printed, a document to be printed, or a document to be transmitted to an external device.

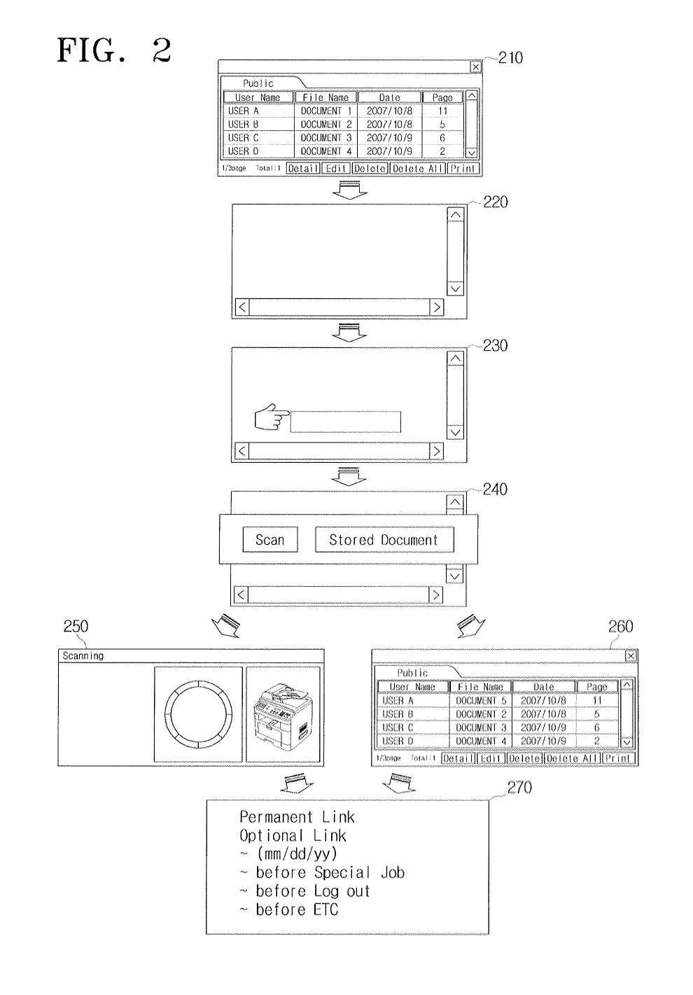

FIGS. 2 to 4 are exemplary views illustrating various examples of a user interface window displayed in the image forming apparatus 100 of FIG. 1. As illustrated in FIG. 2, a list 210 of documents previously stored in the image forming apparatus 100 is displayed.

If the user selects document 1 from among the previously stored documents, the selected document may appear on a user interface window 220. Subsequently, if the user designates a link location, on which the link information will be displayed, as illustrated in a user interface window 230 in order to set a document to be linked, a user interface window 240 may be displayed so that the user can select the type of document to be linked using the user interface window 240. In this situation, if the user selects a new document, a scanning interface window 250 may be displayed, and then the scanning may be performed.

Alternatively, if the user selects the previously stored document, a list 260 of documents currently stored in the image forming apparatus 100 may be displayed, so that the user may set the document to be linked using the displayed list. If the corresponding document to be linked is selected, an interface window 270 may appear in order to receive link attributes of the linked document.

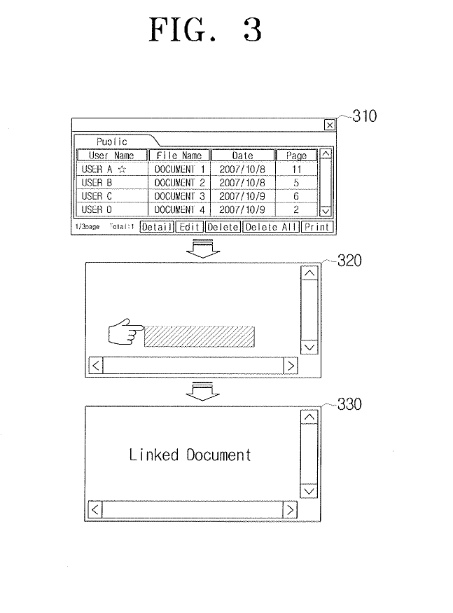

Referring to FIG. 3, a list 310 of documents currently stored in the image forming apparatus 100 is displayed after the process of setting the linked document has been completed as illustrated in FIG. 2. As illustrated in the list 310, document 1 is a document for which a link is established as described above, and an icon such as “a star mark” is displayed next to the user name in order to notify that the link is established for document 1. The user may thereby know that the linked document is set to document 1.

If the user selects the document for which the link is established, both the selected document and information regarding the linked document may be displayed on a user interface window 320. If the user designates a link location on the user interface window 320, the linked document may be displayed on a user interface window 330.

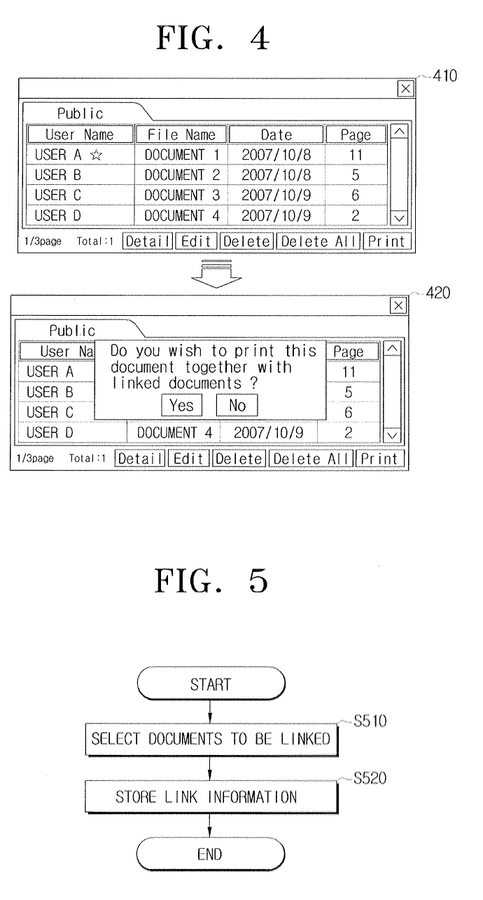

As illustrated in FIG. 4, a list 410 of documents currently stored in the image forming apparatus 100 is displayed. If the user desires to print document 1 for which the link is established, a user interface window 420 may be displayed to check whether document 1 is printed together with the linked document. Accordingly, the user may easily print the linked document together with the current document simultaneously.

It is possible that the document and the linked document can be selectively printed according to a user selection. The window 420 may display a pop-up window to check whether the lined document of document 1 is printed, whether both the document and the linked document are printed, or whether the document is printed. According to a user selection on the window 420, at least one of the document and the linked document can be printed. Therefore, the controller 140 controls the printing unit 160 to print the document and/or the linked document.

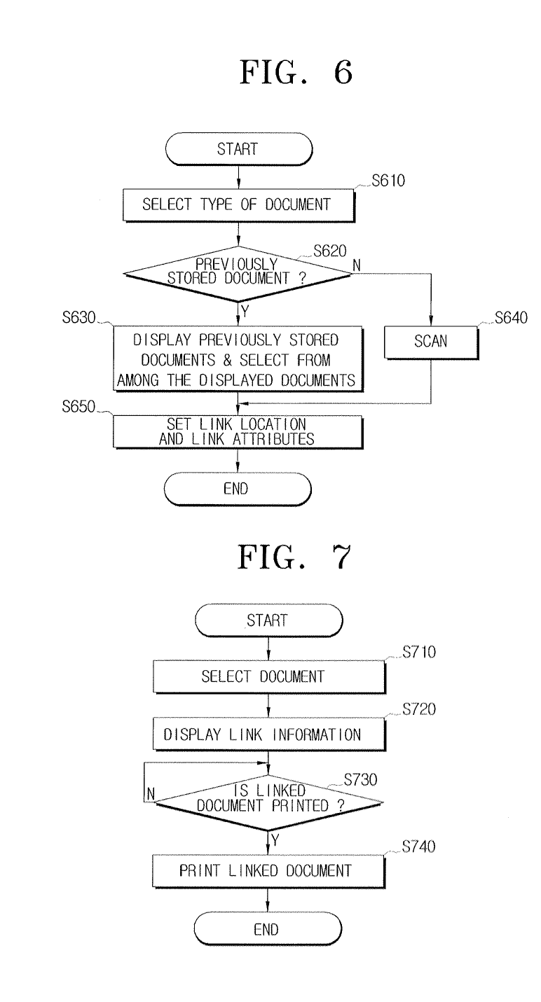

FIGS. 5 and 6 are flowcharts illustrating a document managing method in the image forming apparatus 100. A document to be linked to the current document is selected in operation S510. Information regarding the selected document is stored in operation S520.

Specifically, if there is a document to be linked to the current document, the user may select the type of document to be linked to the current document in operation S610. In this situation, if the user selects a document stored in the image forming apparatus 100, the previously stored documents may be classified according to their attributes, and the classified documents may be displayed. If a document to be linked is selected from among the displayed documents, the selected document may be set to be a linked document in operation S630.

Alternatively, if the document to be linked is a document which will be scanned, scanning may be activated so that the document may be scanned in operation S640. Accordingly, if a document which the user desires to link is not stored in the image forming apparatus 100, the document may be scanned by the scanning unit 130 of the image forming apparatus 100, and the scanned document may be stored, so that the stored document may be set to be a linked document in operation S630.

If the linked document is set, the link location and link attributes of the linked document may be set in operation S650. During operation S650, the user may decide how to display the linked document when the user desires to select or print the linked document. In this exemplary embodiment of the present general inventive concept, the link location and link attributes may be set according to the system settings.

FIG. 7 is a flowchart illustrating a method of using a document for which a link is established in the image forming apparatus 100. If the user selects a document for which the link is established in operation S710, the link information may be displayed along with the linked document on the link location set in the linked document in operation S720. For example, when setting the link location, the user may display a notification stating that the linked document exists on one side of the document set by the user. The notification may be a document name or name set by the user, or may be displayed using underlines or by flashing on the screen.

If the user desires to print the document for which the link is established in operation S730, whether the linked document is printed may be determined. Specifically, a user interface window may be output to ask the user to confirm whether to print the linked document, and the current document and linked document may be printed according to the user's selection in operation S740. In this exemplary embodiment of the present general inventive concept, asking the user to confirm whether to print the linked document will be omitted, and whether the linked document is printed may be determined using information of the link attributes stored when the link is established. Thus, the user may easily manage the linked documents that will be processed together with the current document.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

The image forming apparatus according to exemplary embodiments of the present general inventive concept links a related document to a current document, and thus a user may easily check and manage the current document and linked documents associated with the current document, which increases user convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of managing a document in an image forming apparatus, the method comprising:
receiving a selection of a document to be linked to a current document; and
storing information regarding the selected document to be linked, in the current document.

2. The method of claim 1, wherein the receiving comprises:
if the document to be linked is selected from among previously stored documents, displaying the previously stored documents and receiving a selection of at least one of the displayed documents; and
if the document to be linked is a document to be scanned, activating a scanning function to scan the document to be linked.

3. The method of claim 2, wherein the previously stored documents are stored in a storage medium of the image forming apparatus or in a storage medium of an external host device connected to the image forming apparatus.

4. The method of claim 1, further comprising:
receiving a setting of at least one of a link location and a link attribute.

5. The method of claim 4, wherein the link attribute is at least one of a link attribute validity period and information regarding whether a linked document is automatically printed.

6. The method of claim 1, further comprising:
displaying information regarding the linked document on a link location pre-set in the current document.

7. The method of claim 6, further comprising:
if the displayed information regarding the linked document is selected, displaying the linked document corresponding to the selected information, instead of the current document.

8. The method of claim 6, further comprising:
if the displayed information regarding the linked document is selected, displaying the selected information together with the linked document corresponding to the selected information.

9. The method of claim 1, further comprising:
if a command to print the current document is received, printing at least one of the current document and the linked document.

10. The method of claim 9, further comprising:
receiving a selection of whether the linked document is printed,
wherein the printing comprises printing the linked document according to a user's selection.

11. An image forming apparatus comprising:
a storage unit;
an operating unit to receive a selection of a document to be linked to a current document; and
a controller to link information regarding the selected document to the current document using the operating unit, and to store the current document including the link information in the storage unit.

12. The image forming apparatus of claim 11, further comprising:
a scanning unit,
wherein the document to be linked is a document scanned by the scanning unit.

13. The image forming apparatus of claim 11, further comprising:
a display unit to display documents previously stored in the storage unit,
wherein the controller links a document selected from among the displayed documents to the current document.

14. The image forming apparatus of claim 11, wherein, if at least one of a link location and a link attribute of the linked document is selected through the operating unit, the controller matches the selected link location and link attribute to the current document and stores the matched document in the storage unit.

15. The image forming apparatus of claim 14, wherein the link attribute is at least one of a link attribute validity period and information regarding whether a linked document is automatically printed.

16. The image forming apparatus of claim 11, further comprising:
a display unit to display the current document together with information regarding the linked document, if a command to display the current document is received.

17. The image forming apparatus of claim 16, wherein, if the information regarding the linked document displayed on the display unit is selected, the controller displays the linked document corresponding to the selected information on the display unit, instead of the current document.

18. The image forming apparatus of claim 17, wherein, if the information regarding the linked document displayed on the display unit is selected, the controller displays the selected information together with the linked document corresponding to the selected information on the display unit.

19. The image forming apparatus of claim 11, further comprising:
a printing unit,
wherein, if a command to print the current document is received, the controller controls the printing unit to print at least one of the current document and the linked document.

20. The image forming apparatus of claim 19, wherein the controller controls the printing unit to print the linked document according to a user's selection.

21. A computer-readable medium to contain computer-readable codes as a program to execute a method of managing a document in an image forming apparatus, the method comprising:
receiving a selection of a document to be linked to a current document; and
storing information regarding the selected document to be linked, in the current document.

22. An image forming apparatus comprising:
a controller to generate information on a document and a second document linked to the document and to perform an operation on the document and the linked document;
a display unit to display the information; and
a scanning unit to scan an external document as at least one of the document and the linked document.

23. The image forming apparatus of claim 22, further comprising:
a printing unit to print at least one of the document and the linked document.

24. The image forming apparatus of claim 22, wherein the operation comprises one of a printing operation to print the document and the linked document, a displaying operation to display the document and the linked document, a scanning operation to scan at least one of the document and the linked document, a communicating operation to communicate with an external device to receive and transmit the document and the linked document.
